(19) United States
(12) Patent Application Publication
(10) Pub. No.: US 2026/0213510 A1
(43) Pub. Date: Jul. 23, 2026

(54) Writing Receptacle

(71) Applicant: Joseph Michael Auricchio, III, Tucson, AZ (US)

(72) Inventor: Joseph Michael Auricchio, III, Tucson, AZ (US)

(21) Appl. No.: 19/035,697

(22) Filed: Jan. 23, 2025

(51) Int. Cl. H02G 3/08

(52) U.S. Cl. CPC H02G 3/081; H02G 2200/20

(57) ABSTRACT

1. A typical electrical outlet or light switch is made of one piece.
2. New outlet cover has two pieces.
3. A two-piece outlet cover keeps electrical circuit information in place when the outer cover is removed for maintenance, inspection, or painting purposes.

### BACKGROUND OF THE INVENTION

This new electrical outlet cover relates to the electrical industry.

All but one of the pictures of the existing devices and prototypes were taken by the inventor, Joseph Auricchio.

Prototypes were made by Joseph Auricchio, the inventor.

One picture of a Legrand Inc. product.

### SUMMARY OF THE INVENTION

Receptacle covers for electrical receptacles and light switches are one piece. They are normally made from materials like wood, plastic, Lexan, and stainless steel. This invention is new two-piece receptacle cover. This new cover will keep electrical circuit information in place even when the outer cover is removed for inspection, service, or painting the wall.

### BRIEF DESCRIPTION OF DRAWINGS

FIG. 1—typical one-piece electrical cover

FIG. 2—typical one-piece light switch cover

FIG. 3—one-piece cover with windows from Legrand Inc.

FIG. 4—example of labeled one-piece electrical outlet cover.

FIG. 5—example of labeled one-piece light switch cover.

FIG. 6—prototype of two-piece cover on electrical outlet with both covers in place.

FIG. 7—prototype of two-piece cover on electrical outlet with outer cover removed and the inner cover in place.

FIG. 8—prototype of two-piece cover on light switch with both covers in place.

FIG. 9—prototype of two-piece cover on light switch with outer cover removed and the inner cover in place.

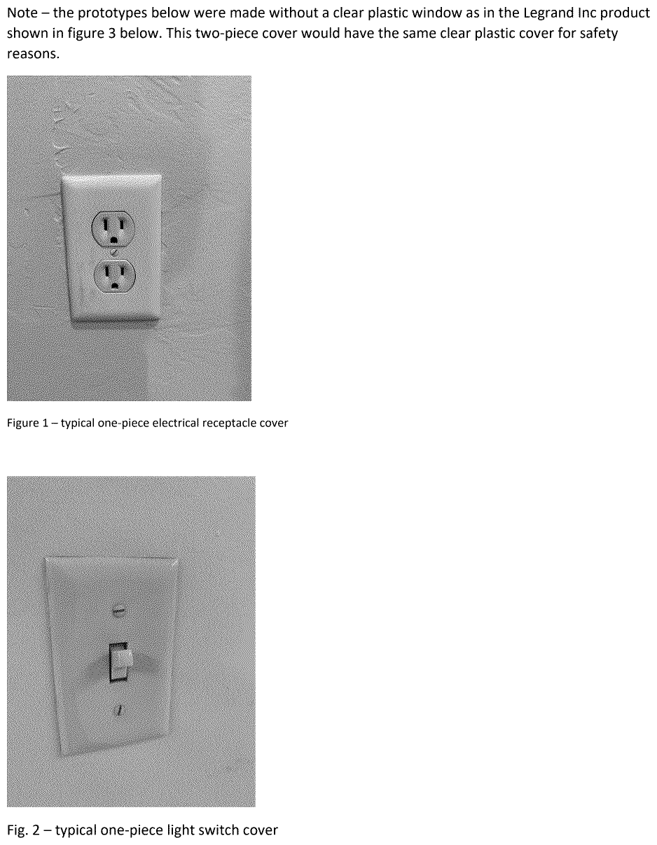

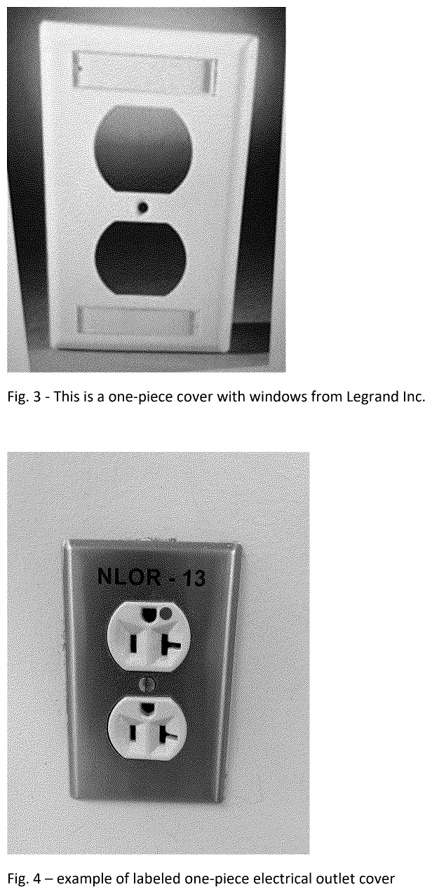

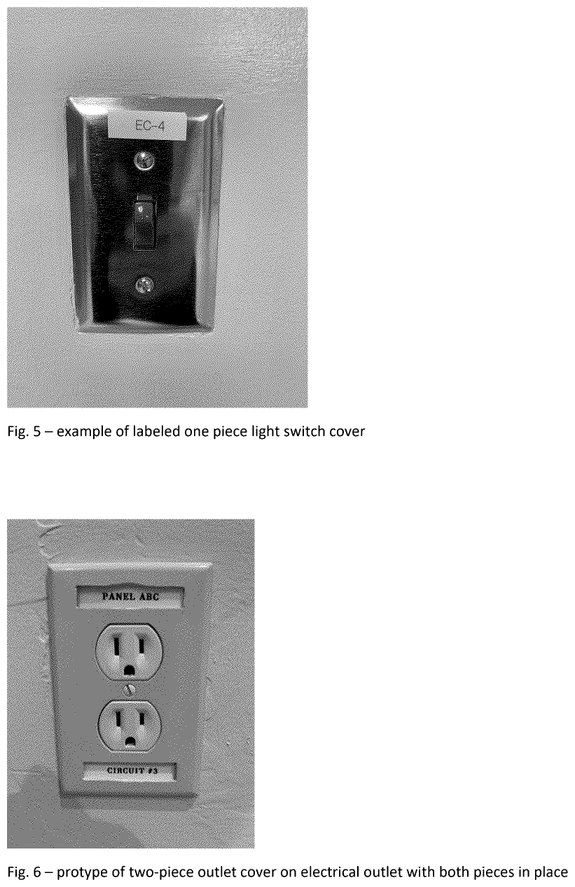

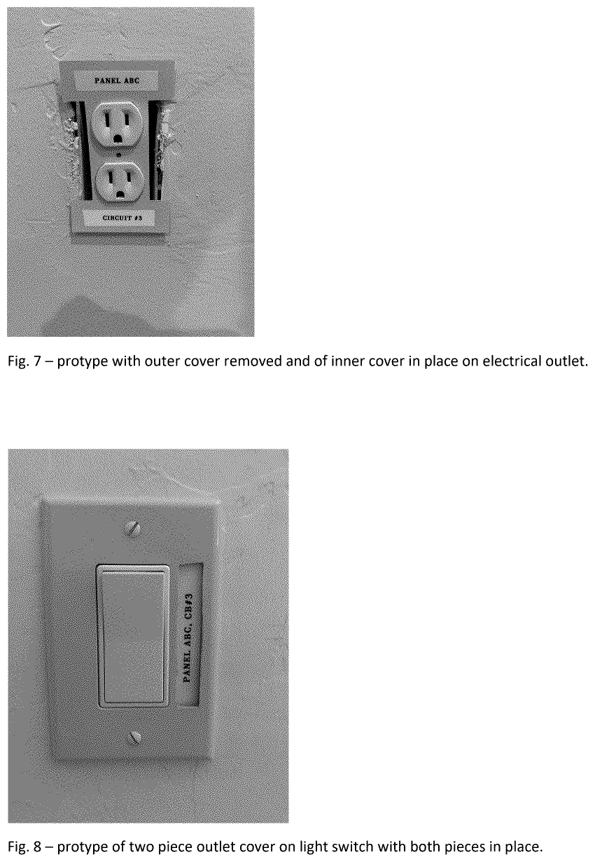

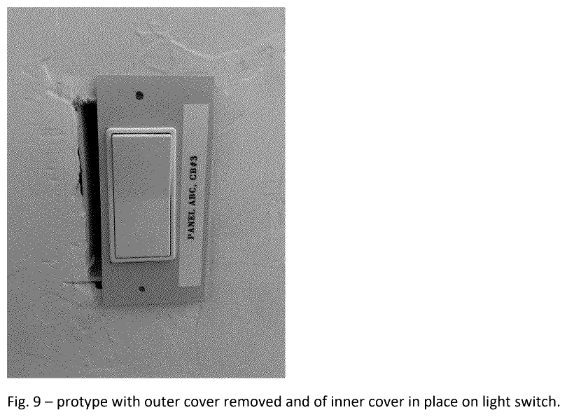

### DETAILED DESCRIPTION OF THE INVENTION

In the last couple of years, Facility Managers have started to label electrical receptacle and light switch covers with the electrical panel and circuit breaker number that feeds power to that device. This is done to help know which circuit needs to be turned off while doing general maintenance or troubleshooting an issue. The problem is the label on a one-piece outlet cover can easily be removed with the cover and the circuit information might be lost. When multiple covers in the same space are removed, they sometimes get mixed up and when re-installed the receptacle and/or switch cover is now labeled with the wrong circuit information. This is especially dangerous in hospitals when turning off electrical power could turn off a patient's life supporting equipment. This new device is comprised of a two-piece cover. The inner cover has a designated space or spaces that lists electrical circuit information. The outer cover has a window or windows that shows the information on the inner cover. The outer cover can be removed to access the receptacle or switch to check for power and inspect the receptacle box. The inner cover, which has the designated circuit information, stays in place. This is also very useful when painting the space and all the receptacle covers are removed. The outer (unlabeled) cover can be removed and the inner (labeled) cover stays in place. This eliminates the need to worry about sorting covers and leaves vital information on the receptacle and light switch at all times.

1. This receptacle cover is unique because it has two cover, the inner and outer covers. Having two covers keeps electrical circuit information in place on the inner cover when the outer cover is removed.
